(19) United States
(12) Patent Application Publication
(10) Pub. No.: US 2019/0302598 A1
(43) Pub. Date: Oct. 3, 2019

(54) PROJECTION DEVICE, PROJECTION METHOD, AND PROJECTION CONTROL PROGRAM

(71) Applicant: SHARP KABUSHIKI KAISHA, Sakai City, Osaka (JP)

(72) Inventors: TAKUTO ICHIKAWA, Sakai City (JP); MAKOTO OHTSU, Sakai City (JP); TAICHI MIYAKE, Sakai City (JP)

(21) Appl. No.: 16/317,288

(22) PCT Filed: Jul. 12, 2017
(86) PCT No.: PCT/JP2017/025376

§ 371 Date: Jan. 11, 2019

(30) Foreign Application Priority Data
Jul. 12, 2016 (JP) 2016-138024

(51) Int. Cl. G03B 21/20; H04N 13/388

(52) U.S. Cl. CPC G03B 21/2053; H04N 13/388

(57) ABSTRACT

In a projection device for projecting content onto a projection medium, a projection area is set up in such a manner as to restrain the visibility of the content from being reduced by the brightness of the projection medium. A projection device for projecting content onto a projection medium detects an illumination intensity distribution on a projection surface of the projection medium and determines a projection area for the content by referring to the illumination intensity distribution.

### TECHNICAL FIELD

The present invention, in an aspect thereof, relates to projection devices, projection methods, and projection programs for projecting content on projection media.

### BACKGROUND ART

AR (augmented reality) technology has been developed that can superimpose video or like content in a real space to present information in such a manner that people can understand it intuitively. AR technology is capable of, for example, superimposing, on site, a video or like content representing how to work on an object and superimposing, in clinical practice, a clinical image or like content on a patient's body.

There are some approaches to AR, including optical see-through, video see-through, and projection techniques. When two or more persons view the same AR information simultaneously, however, optical see-through and video see-through systems require each person to wear a dedicated device. On the other hand, projection-based AR advantageously allows two or more persons to view the same AR information simultaneously without having to require them to wear a dedicated device.

Projection-based AR projects computer-generated or -edited visual information such as graphics, text, still images, and videos from a projection device onto an object in a real space in order to superimpose the visual information on the object.

Projection-based AR employs that mechanism and for this reason has a problem that the visibility of the projected visual information (e.g., video) falls if the object is lit up by external light such as artificial lighting. In an attempt to address this problem, Patent Literature 1 discloses a method of adjusting the brightness of projected video in accordance with the immediate environment of the object. Meanwhile, Patent Literature 2 discloses a method of automatically adjusting the color of projected video by taking account of the color of the object.

### CITATION LIST

### Patent Literature

Patent Literature 1: Japanese Unexamined Patent Application Publication, Tokukai, No. 2013-195726

Patent Literature 2: Japanese Unexamined Patent Application Publication, Tokukai, No. 2012-68364

### SUMMARY OF INVENTION

### Technical Problem

The inventors of the present invention have worked on a unique concept and investigated how a projection area should be set up for a projection device that projects content onto a projection medium in order to restrain the visibility of the content from being reduced by the brightness of the projection medium. No conventional art has ever considered setting up a projection area.

The present invention, in an aspect thereof, has been made in view of this problem and has a major object to provide a technique to set up a projection area for a projection device that projects content onto a projection medium in such a manner as to restrain the visibility of the content from being reduced by the brightness of the projection medium.

### Solution to Problem

To address the problem, the present invention, in one aspect thereof, is directed to a projection device including: a projection unit configured to project content onto a projection medium; and a projection area determining unit configured to determine a projection area for the content based on an illumination intensity of a projectable region for the projection unit.

The present invention, in another aspect thereof, is directed to a method of a projection device projecting content onto a projection medium, the method including the projection area determining step of determining a projection area for the content based on an illumination intensity of a projectable region for the projection device.

### Advantageous Effects of Invention

The present invention, in an aspect thereof, can set up a projection area for a projection device that projects content onto a projection medium in such a manner as to restrain the visibility of the content from being reduced by the brightness of the projection medium.

### BRIEF DESCRIPTION OF DRAWINGS

FIG. 1 is a schematic diagram of an exemplary usage of a projection device in accordance with an embodiment of the present invention (Embodiment 1).

FIG. 2 is a diagram of an exemplary configuration of functional blocks in a projection device in accordance with an embodiment of the present invention (Embodiment 1).

FIG. 3 is a diagram of an exemplary configuration of functional blocks in an illumination intensity distribution acquisition unit in accordance with an embodiment of the present invention (Embodiment 1).

FIG. 4 is a diagram illustrating a method of detecting an illumination intensity distribution in an embodiment of the present invention (Embodiment 1).

FIG. 5 is a diagram illustrating a method of determining a projection area in accordance with an embodiment of the present invention (Embodiment 1).

FIG. 6 is a flow chart for an exemplary operation of a projection device in accordance with an embodiment of the present invention (Embodiment 1).

FIG. 7 is a diagram illustrating a method of determining a projection area in accordance with an embodiment of the present invention (Embodiment 2).

FIG. 8 is a flow chart for an exemplary operation of a projection device in accordance with an embodiment of the present invention (Embodiment 2).

FIG. 9 is a diagram of an exemplary configuration of functional blocks in an illumination intensity distribution acquisition unit in accordance with an embodiment of the present invention (Embodiment 3).

FIG. 10 is a diagram illustrating a method of acquiring a disparity image in accordance with an embodiment of the present invention (Embodiment 3).

FIG. 11 is a diagram illustrating a method of acquiring a disparity image in accordance with an embodiment of the present invention (Embodiment 3).

FIG. 12 is a diagram showing a data structure of content information in accordance with an embodiment of the present invention (Embodiment 4).

### DESCRIPTION OF EMBODIMENTS

### Embodiment 1

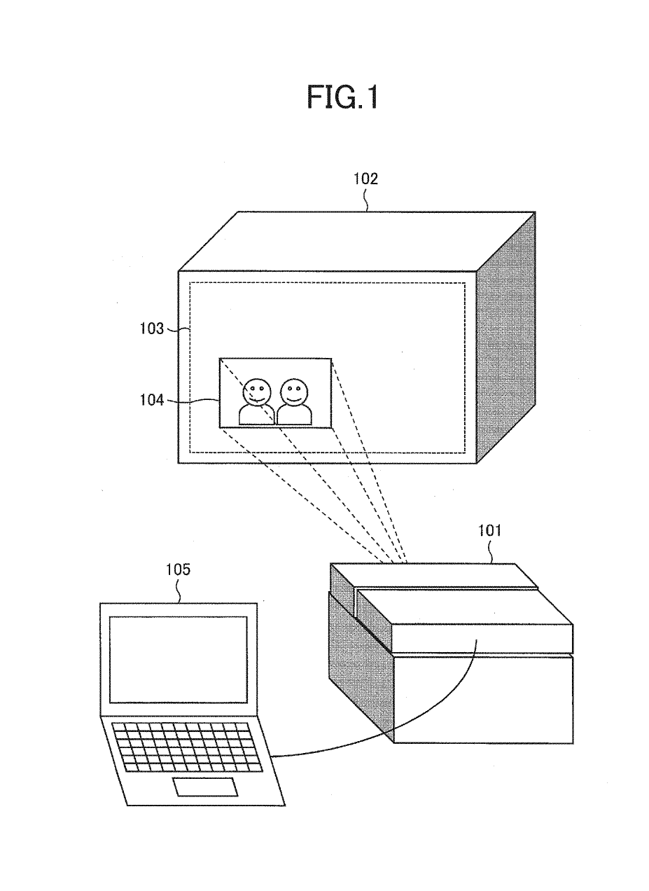

The following will describe an embodiment of the present invention (Embodiment 1) in reference to FIGS. 1 to 6. FIG. 1 is a schematic diagram of an exemplary usage of a projection device 101 in accordance with the present embodiment. The projection device 101 is capable of displaying (projecting) video on an object in a superimposed manner. FIG. 1 shows the projection device 101 being used to project the content provided by an external input device 105 onto a projection medium 102.

In the example shown in FIG. 1, the projection device 101 operates as detailed in the following. The projection device 101 acquires information including content (hereinafter, “content information”) from the external input device 105. The projection device 101 detects a projection surface 103 (projectable region) of the projection medium 102. A “projection surface” refers to a surface of the projection medium 102 onto which the projection device 101 can project content. The projection device 101 also detects an illumination intensity distribution on the detected projection surface 103. The projection device 101 determines a projection area 104 on the projection surface 103 on the basis of the detected illumination intensity distribution. The projection device 101 also projects content onto the determined projection area 104. In other words, the projection medium 102 is an equivalent of a projection screen onto which content is projected, and the projection device 101 projects content onto the projection surface 103 of the projection medium 102.

The projection device 101 may project any type of content including videos (moving images), graphics, text, symbols, still images, and combinations thereof. The projection device 101 projects video as an example throughout the following embodiments. The present invention, in any aspect thereof, is not limited to this example.

### Configuration of Functional Blocks

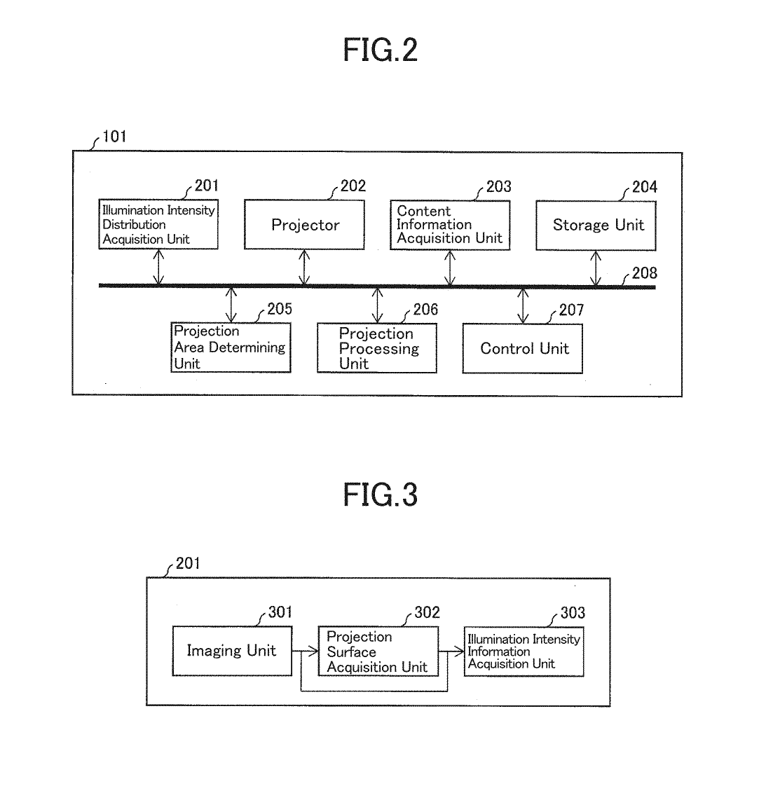

FIG. 2 is a diagram of an exemplary configuration of functional blocks in the projection device 101 in accordance with the present embodiment. Referring to FIG. 2, the projection device 101 includes an illumination intensity distribution acquisition unit (illumination intensity distribution detection unit) 201, a projector (projection unit) 202, a content information acquisition unit 203, a storage unit 204, a projection area determining unit 205, a projection processing unit (graphic data generating unit) 206, a control unit 207, and a data bus 208.

The illumination intensity distribution acquisition unit 201 detects the location of the projection surface of the projection medium 102 and detects an illumination intensity distribution on the detected projection surface 103. The illumination intensity distribution acquisition unit 201 will be described later in more detail.

The projector 202 projects video onto the projection medium 102. The projector 202 may be built around, for example, a DLP (digital light processing) projector or a liquid crystal projector in an aspect of the present invention. The projector 202 projects video using the graphic data generated by the projection processing unit 206 in an aspect of the present invention.

The content information acquisition unit 203 acquires content information containing video to be projected. The content information acquisition unit 203 may be built around, for example, an FPGA (field programmable gate array) or an ASIC (application specific integrated circuit) in an aspect of the present invention.

The content information acquisition unit 203 acquires content information from the external input device 105 in an aspect of the present invention. In such an aspect of the present invention, the content information acquisition unit 203 may have a USB (universal serial bus) or like input/output port as an interface for the external input device 105. The content information acquisition unit 203 acquires content information via the input/output port. The external input device 105 may be any device capable of outputting content information. The external input device 105 may be built around, for example, a content information input device that allows direct input of content information via, for example, a keyboard and/or a mouse, a content information generating device that generates content information, or an external storage device that contains pre-generated content information.

The content information acquisition unit 203 may store the acquired content information in the storage unit 204 in an aspect of the present invention. The content information may have any data format and may be either of general-purpose data format, for example, bitmap or jpeg (joint photographic experts group) for a still image and avi (audio video interleave) or fly (flash video) for a video (moving image) or of proprietary data format. The content information acquisition unit 203 may convert the acquired content information to a different data format.

The storage unit 204 contains the content information acquired by the content information acquisition unit 203, results of video processing, and other various data used in video processing. The storage unit 204 may be built around, for example, a RAM (random access memory), hard disk, or other like storage device in an aspect of the present invention.

The projection area determining unit 205 determines the projection area 104 onto which video is to be projected, by referring to the illumination intensity distribution detected on the projection surface 103 by the illumination intensity distribution acquisition unit 201. The projection area determining unit 205 may be built around, for example, an FPGA or an ASIC in an aspect of the present invention. A method of determining a projection area will be described later in detail.

The projection processing unit 206 generates graphic data to be used to project video onto the projection area 104 determined by the projection area determining unit 205 and outputs the generated graphic data to the projector 202. The projection processing unit 206 may be built around, for example, an FPGA, an ASIC, or a GPU (graphics processing unit) in an aspect of the present invention.

The control unit 207 controls the entire projection device 101. The control unit 207 is built around, for example, a CPU (central processing unit) and executes control related to instructions, control, and data input/output for processes performed by functional blocks. The data bus 208 is a bus for data transfer between the units.

The projection device 101 contains the above-mentioned functional blocks in a single housing as shown in FIG. 1 in an aspect of the present invention. The present embodiment is however not limited by this example. In another aspect of the present invention, some of the functional blocks may be contained in a different housing. For example, the projection device 101 may include a general-purpose personal computer (PC) that serves as the content information acquisition unit 203, the storage unit 204, the projection area determining unit 205, the projection processing unit 206, and the control unit 207 in an aspect of the present invention. In another aspect of the present invention, for example, a PC may be used to provide a device that includes the storage unit 204 and the projection area determining unit 205 to determine an area onto which video is to be projected by the projection device 101.

### Configuration of Illumination Intensity Distribution Acquisition Unit

FIG. 3 is a diagram of an exemplary configuration of functional blocks in the illumination intensity distribution acquisition unit 201 in accordance with the present embodiment. Referring to FIG. 3, the illumination intensity distribution acquisition unit 201 includes an imaging unit 301, a projection surface acquisition unit 302, and an illumination intensity information acquisition unit 303.

The imaging unit 301 captures an image 401 of an area including the projection medium 102. In an aspect of the present invention, the imaging unit 301 is configured to include: optical components for capturing an image of an imaging space; and an imaging device such as a CMOS (complementary metal oxide semiconductor) or a CCD (charge coupled device). The imaging unit 301 generates image data representing the image 401 from electric signals generated by the imaging device through photoelectric conversion. The imaging unit 301, in an aspect of the present invention, may output raw generated image data, may first subject the generated image data to image processing such as luminance imaging and/or noise reduction in a video processing unit (not shown) before outputting the image data, and may output both the raw generated image data and the processed image data. Furthermore, the imaging unit 301 may be configured so as to transmit output images complete with camera parameters used in the imaging such as an aperture value and a focal length to the storage unit 204.

The projection surface acquisition unit 302 detects the location of the projection surface 103 (projectable region) by referring to the image 401 captured by the imaging unit 301. The imaging unit 301 captures an image covering an area that is not smaller than the projection surface 103. In addition, the imaging unit 301 captures an image covering an area that is not smaller than a projectable region for the projector 202. The projection surface acquisition unit 302, in the present embodiment, detects the location of the projection surface 103 as two-dimensional coordinates defined on the image 401. The projection surface acquisition unit 302 may store the detected coordinates in the storage unit 204 in an aspect of the present invention.

The projection surface acquisition unit 302 may detect the location (coordinates) of the projection surface 103 by using the external input device 105 in an aspect of the present invention. For example, in an aspect of the present invention, the external input device 105 may be a mouse or like input device that is capable of specifying a location, and the projection surface acquisition unit 302 may acquire the location (coordinates) of the projection surface 103 by receiving an input of positions on the image 401 that correspond to the vertices of the projection surface 103 from a user via the external input device 105.

The projection surface acquisition unit 302 may detect the location (coordinates) of the projection surface 103 by processing the image 401 in another aspect of the present invention. For example, in an aspect of the present invention, the projector 202 may project a marker image that have a characteristic form onto the four (upper left, lower left, upper right, and lower right) vertices of a video so that the projection surface acquisition unit 302 can estimate the location (coordinates) of the projection surface 103 by detecting the marker images in the image 401 through pattern matching.

The illumination intensity information acquisition unit 303 refers to the image 401 captured by the imaging unit 301 and the location (coordinates) of the projection surface 103 detected by the projection surface acquisition unit 302 in detecting an illumination intensity distribution on the projection surface 103. The illumination intensity information acquisition unit 303 may be built around, for example, an FPGA or an ASIC in an aspect of the present invention. A method of detecting an illumination intensity distribution implemented by the illumination intensity information acquisition unit 303 will be described later in detail.

### Method of Detecting Illumination Intensity Distribution

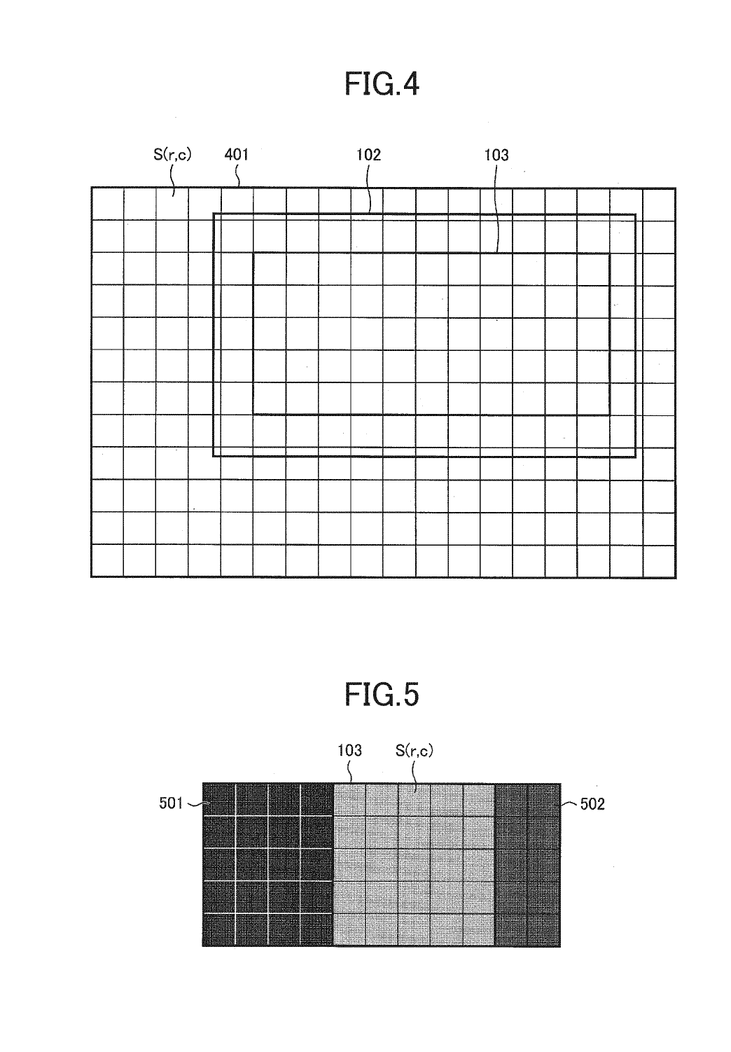

A method of detecting an illumination intensity distribution implemented by the illumination intensity information acquisition unit 303 will be described next in reference to FIG. 4. FIG. 4 shows an example of the image 401 captured by the imaging unit 301 being divided into a plurality of subareas. A subarea in the r-th row and the c-th column will be denoted by S(r,c).

The illumination intensity information acquisition unit 303, in an aspect of the present invention, refers to the location (coordinate) of the projection surface 103 detected by the projection surface acquisition unit 302, identifies subareas of the projection surface 103, and measures illumination intensity for each of the subareas identified, in order to detect an illumination intensity distribution on the projection surface 103. In an aspect of the present invention, illumination intensity may be measured for each subarea using, for example, a TTL (through-the-lens) exposure meter or like general-purpose illumination intensity measuring instrument in an aspect of the present invention. In another aspect of the present invention, the illumination intensity information acquisition unit 303 may calculate illumination intensity from the luminance level of the image 401 captured by the imaging unit 301 (see Masahiro SAKAMOTO, Natsuki ANDO, Kenji OKAMOTO, Makoto USAMI, Takayuki MISU, and Masao ISSHIKI, “Study of an illumination measurement using a digital camera image,” 14th Forum on Information Science and Technology, pp 223-226, 2015). In calculating illumination intensity from the luminance level of the image 401 captured by the imaging unit 301, the luminance level of the image 401 may reflect either (i) only the brightness of the projection surface 103 or (ii) the brightness of the space expanding between the projection device 101 and the projection surface 103 as well as the brightness of the projection surface 103. As an example, if there exists mist or a like light-reflecting (light-scattering) body in the space between the projection device 101 and the projection surface 103, and the space is illuminated, the light reflected (scattered) by the light-reflecting (light-scattering) body reaches the projection device 101, thereby contributing to the luminance level of the image 401. Therefore, the illumination intensity (illumination intensity distribution) described in the present specification accounts for not only case (i), but also case (ii).

The illumination intensity information acquisition unit 303 may output illumination intensity distribution information representing the detected illumination intensity distribution to the storage unit 204 in an aspect of the present invention. Illumination intensity in a subarea S(r,c) will be denoted by I(S(r,c)).

### Method of Determining Projection Area

A method of determining a projection area implemented by the projection area determining unit 205 will be described next in reference to FIG. 5. FIG. 5 is a diagram representing an exemplary illumination intensity distribution on the projection surface 103 detected by the illumination intensity distribution acquisition unit 201. FIG. 5 uses a darker color to represent a lower illumination intensity and a brighter color to represent a higher illumination intensity.

First, the projection area determining unit 205 refers to the illumination intensity distribution detected by the illumination intensity distribution acquisition unit 201 to detect subareas that have an illumination intensity lower than or equal to a predetermined illumination intensity threshold ThI out of all the subareas into which the projection surface 103 is divided. The illumination intensity threshold ThI is, for example, contained in the storage unit 204. Subsequently, the projection area determining unit 205 detects, as a subarea group, a rectangular area composed of contiguous subareas S out of the detected subareas in an aspect of the present invention. FIG. 5 shows an example where the projection area determining unit 205 detects a subarea group 501 and a subarea group 502. In another aspect of the present invention, the projection area determining unit 205 may detect a non-rectangular area as a subarea group. The projection area determining unit 205, in a further aspect of the present invention, may detect only areas greater than or equal to an area threshold ThII as a subarea group.

The projection area determining unit 205 then calculates an average illumination intensity for each subarea group in an aspect of the present invention. Equation 1 below gives an average illumination intensity V(i) of a subarea group G(i), where i is the number assigned to a subarea group, G(i) is the subarea group identified by that number i, and N(i) is the number of subareas in the subarea group G(i).

$$\begin{matrix}[ Math . 1 ] & \\ V ( i ) = \frac{1}{N ( i )} \sum I ( S ( r , c ) ) , where S ( r , c ) ∈ G ( i ) & ( Eq . 1 )\end{matrix}$$

The projection area determining unit 205, in an aspect of the present invention, then compares the average illumination intensities V(i) of the subarea groups to identify, as the projection area 104, the subarea group G(i) for which Equation 2 gives a minimum average illumination intensity A. In Equation 2, k is the number of subarea groups.

$$\begin{matrix}[ Math . 2 ] & \\ A = min ( V ( i ) ) & ( Eq . 2 )\end{matrix}$$

The projection area determining unit 205 of the present embodiment needs only to be configured to identify the projection area 104 in the detected subarea groups. The projection area determining unit 205 does not necessarily determine a subarea group with a minimum average illumination intensity as the projection area 104 as described above. For example, in another aspect of the present invention, the projection area determining unit 205 may determine a subarea group occupying a maximum area as the projection area 104. In the present embodiment (Embodiment 1), illumination intensity is measured for each subarea of the projection surface, and a plurality of subarea groups is detected on the projection surface before the average illumination intensities of the subarea groups are compared. Alternatively, as soon as a subarea group with an average illumination intensity lower than a prescribed threshold is identified on a projection surface, that subarea group may be determined as the projection area 104.

As a further alternative, if the projection area determining unit 205 has failed to determine the projection area 104, for example, if the projection area determining unit 205 has failed to detect a subarea that has an illumination intensity lower than or equal to the illumination intensity threshold ThI, the projection device 101 may, for example, stop the video projection processing or present a message that prompts a user to darken the environment.

### Method of Generating Graphic Data

A description will be given next of a method of generating graphic data implemented by the projection processing unit 206. The projection processing unit 206 generates graphic data to be used to project video contained in the content information acquired by the content information acquisition unit 203 onto the projection area 104 determined by the projection area determining unit 205.

First, the projection processing unit 206 refers to the projection area 104 determined by the projection area determining unit 205 and acquires the vertex coordinates (m′1, n′1), (m′2, n′2), (m′3, n′3), and (m′4, n′4) of the projection area 104.

Subsequently, the projection processing unit 206 acquires the vertex coordinates (m1, n1), (m2, n2), (m3, n3), and (m4, n4) of the video contained in the content information.

Then, using the vertex coordinates of the projection area 104 and the vertex coordinates of the video contained in the content information, the projection processing unit 206 converts the video contained in the content information to graphic data to be used to project the video onto the projection area 104. The projection processing unit 206 uses the conversion formula of Equation 3 in an aspect of the present invention. This conversion formula can convert pixels (m,n) in the video contained in the content information to pixels (m′,n′) for the graphic data.

$$\begin{matrix}[ Math . 3 ] & \\ ( \begin{matrix}{m}^{′} \\ {n}^{′} \\ 1\end{matrix} ) = {H}^{*} ( \begin{matrix}m \\ n \\ 1\end{matrix} ) & ( Eq . 3 )\end{matrix}$$

In this conversion (Equation 3), H* is a 3×3 matrix and called a homography matrix. A homography matrix is capable of projection transform of two images.

With the elements of the homography matrix being defined as in Equation 4 in an aspect of the present invention, the projection processing unit 206 calculates the values of the 3×3 entries in such a manner as to minimize error in the coordinate conversion performed using Equation 3. Specifically, the projection processing unit 206 calculates the entries to minimize Equation 5. Note that argmin(.) is a function that calculates the parameters below argmin that minimize the value in the parentheses.

$$\begin{matrix}[ Math . 4 ] & \\ {H}^{*} = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) & ( Eq . 4 ) \\ [ Math . 5 ] & \\ {argmin}_{{h}_{11} , … , {h}_{33}} ( {\sum }_{i = 1 , … , 4} {( {m}_{i}^{′} - \frac{{h}_{11} {m}_{i} + {h}_{12} {n}_{i} + {h}_{13}}{{h}_{31} {m}_{i} + {h}_{32} {n}_{i} + {h}_{33}} )}^{2} + {( {n}_{i}^{′} - \frac{{h}_{21} {m}_{i} + {h}_{22} {n}_{i} + {h}_{23}}{{h}_{31} {m}_{i} + {h}_{32} {n}_{i} + {h}_{23}} )}^{2} ) & ( Eq . 5 )\end{matrix}$$

The projection processing unit 206 can hence obtain a matrix that transforms coordinates in the video contained in the content information acquired by the content information acquisition unit 203 to corresponding coordinates in the projection area determined by the projection area determining unit 205. Through transform using this matrix, the projection processing unit 206 can generate graphic data to be used to project the video onto the projection area 104.

### Flow Chart

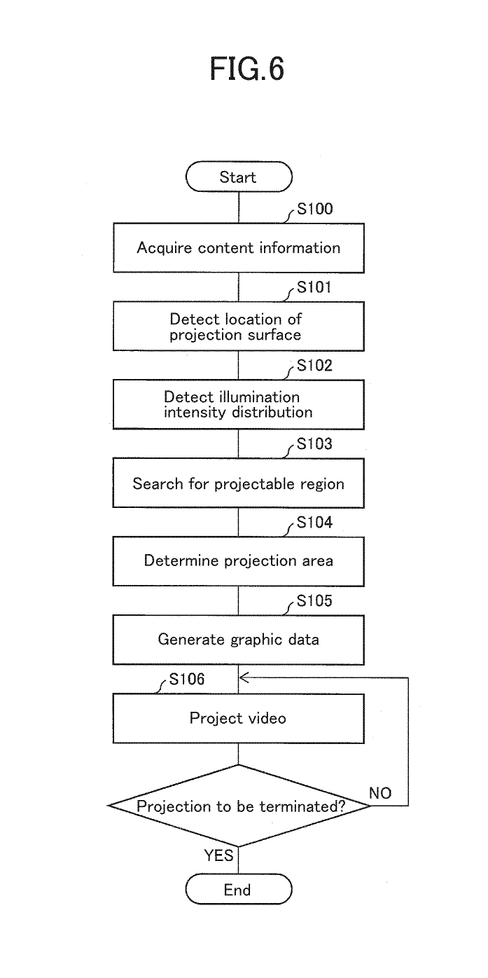

FIG. 6 is a flow chart for an exemplary operation of the projection device 101 in accordance with the present embodiment. Referring to FIG. 6, a description will be given of the projection device 101: detecting an illumination intensity distribution; determining the projection area 104 on the projection surface 103 of the projection medium 102 while referring to the detected illumination intensity distribution; and projecting video onto the projection medium 102 from the projection device 101.

The content information acquisition unit 203, in step S100, acquires content information from the external input device 105 and stores the acquired content information in the storage unit 204. Then, in step S101, the illumination intensity distribution acquisition unit 201 detects the location of the projection surface 103. In step S102, the illumination intensity distribution acquisition unit 201 detects an illumination intensity distribution on the projection surface 103. Next, the projection area determining unit 205, in step S103, compares the illumination intensity distribution detected by the illumination intensity distribution acquisition unit 201 with an illumination intensity threshold contained in the storage unit 204 for video projection, in order to search for areas where illumination intensity satisfies threshold conditions.

Then, in step S104, the projection area determining unit 205 determines one of the areas found in step S103 that has a minimum average illumination intensity as the projection area 104. Thereafter, in step S105, the projection processing unit 206 retrieves the content information acquired by the content information acquisition unit 203 from the storage unit 204, generates graphic data to be used to project the video contained in the content information onto the projection area 104 determined by the projection area determining unit 205, and outputs the generated graphic data to the projector 202. Then, in step S106, the projector 202 projects the video onto the projection area 104 of the projection medium 102 by using the received graphic data.

In step S107, the control unit 207 determines whether or not to terminate the projection. If the projection is not to be terminated, but continued (NO in step S107), the process returns to step S106, and the projection described here is repeated. If the projection is to be terminated (YES in step S107), the process is completely terminated.

The arrangement described above provides a method by which the projection device 101 for projecting video onto the projection medium 102 can project video by acquiring an illumination intensity distribution on the projection surface 103 of the projection medium 102 and specifying the projection area 104 in accordance with the acquired illumination intensity distribution. The method can restrain the visibility of content from being reduced by the brightness of the projection medium 102.

The present embodiment (Embodiment 1) measures illumination intensity for each subarea of the projection surface to detect an illumination intensity distribution across the projection surface. In other words, the present embodiment measures illumination intensity in all the subareas of the projection surface. Alternatively, for example, illumination intensity may be measured for only some, not all, of the subareas of the projection surface, and an illumination intensity distribution can still be obtained from the measurements. In other words, if illumination intensity is measured for each subarea of the projection surface, detailed information is obtained on the illumination intensity distribution on the projection surface. On the other hand, if illumination intensity is measured for only some of the subareas, rough information is obtained on the illumination intensity distribution on the projection surface.

### Embodiment 2

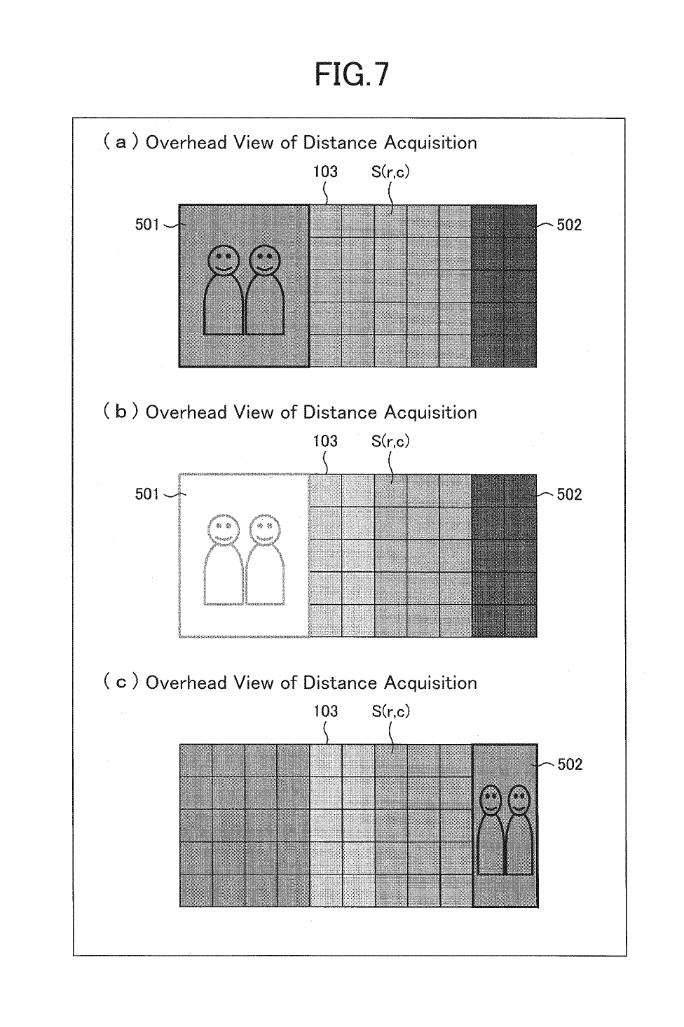

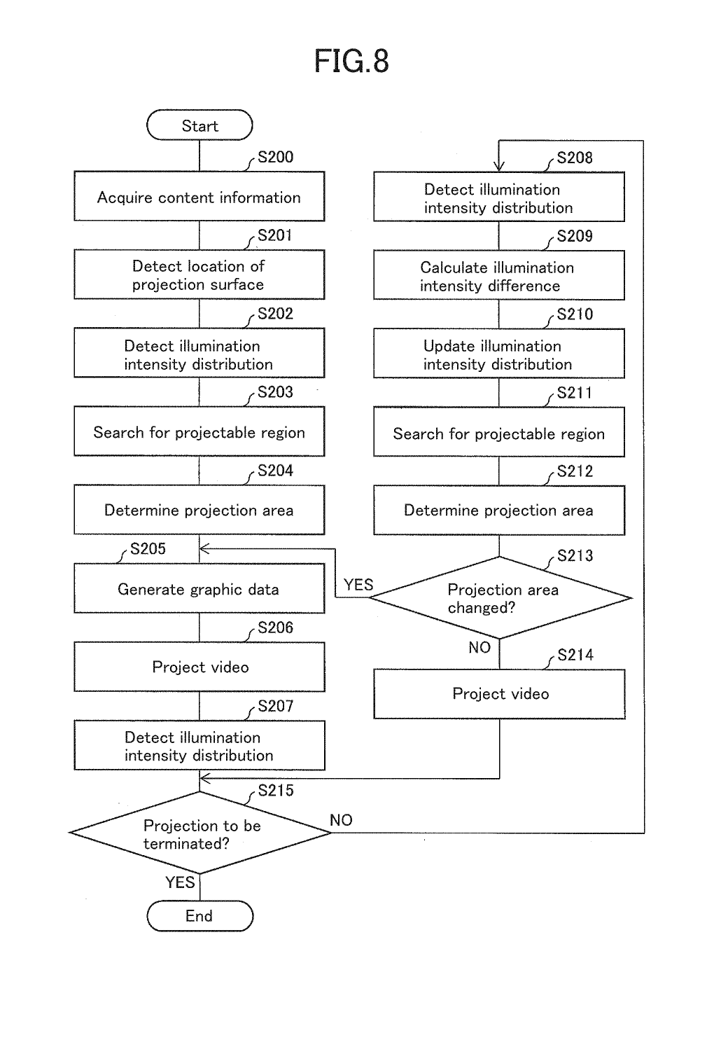

The following will describe another embodiment of the present invention (Embodiment 2) in reference to FIGS. 7 and 8. The present embodiment describes a method of moving the location of a video projection on the projection medium 102 (“projection destination”) to the projection area 104 determined by the projection area determining unit 205 while the video is being projected. For convenience of description, members of the present embodiment that have the same function as members of the previous embodiment are indicated by the same reference numerals, and description thereof is omitted.

In Embodiment 1, the projection device 101 determines the projection area 104 before starting to project a video and projects the video onto the determined projection area 104. A situation can occur in which external lighting conditions change while the video is being projected, which may increase illumination intensity in the projection area 104 and reduce the visibility of the video. Accordingly, in the present embodiment, the illumination intensity distribution acquisition unit 201 detects an illumination intensity distribution and moves the location of the projected video (projection destination) in accordance with results of the detection while the video is being projected. This method can restrain the visibility of the video from being reduced by an increase of illumination intensity in the projection area 104.

In addition, during the projection of a video, illumination intensity on the projection surface 103 rises due to the projection. It is therefore difficult to determine the projection area 104 properly by the method described in Embodiment 1. Accordingly, in the present embodiment, temporal changes of illumination intensity are considered in determining the projection area 104, which enables the projection area 104 to be determined properly even during the projection of a video.

### Configuration of Functional Blocks

The projection device 101 has its functional blocks configured similarly to Embodiment 1 (see FIG. 2), except for the following respects. The present embodiment differs from Embodiment 1 in that in the former, the projection area determining unit 205, while the projector 202 is projecting a video, determines a projection area for the video by additionally referring to an illumination intensity distribution detected in advance by the illumination intensity distribution acquisition unit 201 after the projection is started (“post-start illumination intensity distribution”). More specifically, while the projector 202 is projecting a video, the projection area determining unit 205 refers to the illumination intensity distribution detected by the illumination intensity distribution acquisition unit 201 and also to the post-start illumination intensity distribution detected in advance by the illumination intensity distribution acquisition unit 201 after the projection is started, so that a projection area can be determined with changes in the illumination intensity distribution being taken into consideration. If illumination intensity increases in the projection area due to changes in external lighting conditions during the projection of a video, this configuration can properly alter the projection area, thereby restraining the visibility of the projected video from being reduced. A method of determining a projection area in accordance with the present embodiment will be described later in detail.

### Method of Determining Projection Area

A method of determining a projection area implemented by the projection area determining unit 205 in accordance with the present embodiment will be described next in reference to FIG. 7. FIG. 7 is a diagram illustrating the illumination intensity distribution acquisition unit 201 acquiring an illumination intensity distribution on the projection surface 103 during the projection of a video.

First, the projection area determining unit 205 determines an initial projection area 104 by the method of Embodiment 1 as shown in FIG. 5 before the projector 202 starts to project a video. The illumination intensity detected at this timing by the illumination intensity information acquisition unit 303 for a subarea S(r,c) is denoted by Ib(S(r,c)). The illumination intensity information acquisition unit 303 has a resultant illumination intensity distribution stored as a pre-start illumination intensity distribution in the storage unit 204. FIG. 5 shows an example where the projection area determining unit 205 determines the subarea group 501 as the initial projection area 104.

Subsequently, the projector 202 projects a video onto the subarea group 501 as shown in (a) of FIG. 7. Immediately after the projector 202 has started to project a video, the illumination intensity distribution acquisition unit 201 detects an illumination intensity Ia0(S(r,c)) in each subarea and has a resultant illumination intensity distribution stored as a post-start illumination intensity distribution in the storage unit 204.

Subsequently, while the projector 202 is projecting the video, the illumination intensity distribution acquisition unit 201 acquires illumination intensity Ia(S(r,c)) for one subarea after the other. After the illumination intensity distribution acquisition unit 201 has acquired illumination intensity for all the subareas, the projection area determining unit 205 acquires an illumination intensity difference d(S(r,c)) in accordance with Equation 6.

[Math. 6]

d(S(r,c))=Iₐ(S(r,c))−Iₐ₀(S(r,c)) (Eq.6)

Using this acquired illumination intensity difference d(S(r,c)) and the illumination intensity Ib(S(r,c)) acquired before the projection, the projection area determining unit 205 subsequently calculates an updated illumination intensity I(S(r,c)) on the projection surface 103 according to Equation 7.

[Math. 7]

I(S(r,c))=I_{b}(S(r,c))+d(S(r,c)) (Eq.7)

The projection area determining unit 205 then detects subareas that have an illumination intensity lower than or equal to the illumination intensity threshold ThI to determine the projection area 104 similarly to Embodiment 1, by referring to an updated illumination intensity distribution obtained from the calculated, updated illumination intensity I(S(r,c)). If it turns out that the projection area 104 has changed, the projection device 101 projects the video onto the new projection area 104.

### Flow Chart

FIG. 8 is a flow chart for an exemplary operation of the projection device 101 in accordance with the present embodiment.

The content information acquisition unit 203, in step S200, acquires content information from the external input device 105 and stores the acquired content information in the storage unit 204. Then, in step S201, the illumination intensity distribution acquisition unit 201 detects the location of the projection surface 103. In step S202, the illumination intensity distribution acquisition unit 201 detects an illumination intensity distribution on the projection surface 103. The illumination intensity distribution acquisition unit 201 then outputs the detected illumination intensity distribution as a pre-start illumination intensity distribution to the storage unit 204. Next, the projection area determining unit 205, in step S203, compares the illumination intensity distribution detected by the illumination intensity distribution acquisition unit 201 with an illumination intensity threshold contained in the storage unit 204 for video projection, in order to search for areas (subarea group) where illumination intensity satisfies threshold conditions.

Then, in step S204, the projection area determining unit 205 determines one of the areas found in step S203 that has a minimum average illumination intensity as the projection area 104. Thereafter, in step S205, the projection processing unit 206 retrieves the content information acquired by the content information acquisition unit 203 from the storage unit 204, generates graphic data to be used to project the video contained in the content information onto the projection area 104 determined by the projection area determining unit 205, and outputs the generated graphic data to the projector 202. Then, in step S206, the projector 202 projects the video onto the projection area 104 of the projection medium 102 by using the received graphic data. Immediately after that, the illumination intensity distribution acquisition unit 201 acquires an illumination intensity distribution on the projection surface 103 and outputs the acquired illumination intensity distribution as a post-start illumination intensity distribution to the storage unit 204 in step S207.

While the video is being projected, the process proceeds to step S208 via step S215. In step S208, the illumination intensity distribution acquisition unit 201 detects an illumination intensity distribution on the projection surface 103. Then, the projection area determining unit 205, in step S209, retrieves the post-start illumination intensity distribution from the storage unit 204 and calculates a difference between the post-start illumination intensity distribution and the illumination intensity distribution acquired in step S208. In step S210, the projection area determining unit 205 calculates an updated illumination intensity distribution on the projection surface 103 from the illumination intensity distribution difference calculated in step S209 and the pre-start illumination intensity distribution retrieved from the storage unit 204 (step S210).

Then in step S211, the projection area determining unit 205 compares the updated illumination intensity distribution calculated in step S210 with the illumination intensity threshold contained in the storage unit 204 for video projection, in order to search for areas where illumination intensity satisfies threshold conditions. Then, in step S212, the projection area determining unit 205 determines one of the areas found in step 211 that has a minimum average illumination intensity as the projection area 104.

The control unit 207, in step S213, determines whether or not the projection area 104 determined by the projection area determining unit 205 has changed. If the projection area 104 has not changed (NO in step S213), the projector 202 in step S214 projects video in step S214 using the graphic data received in step S205, before the process proceeds to step S215. If the projection area 104 has changed (YES in step S213), the process returns to step S205, and the aforementioned process is repeated.

In step S215, the control unit 207 determines whether or not to terminate the projection. If the projection is not to be terminated, but continued (NO in step S215), the process returns to step S208. If the projection is to be terminated (YES in step S215), the process is completely terminated.

The arrangement described above provides a method by which the projection device 101 for projecting video onto the projection medium 102 can, while projecting the video onto the projection medium 102, detect an illumination intensity distribution on the projection surface 103 and move the projection area 104 in accordance with the detected illumination intensity distribution.

### Embodiment 3

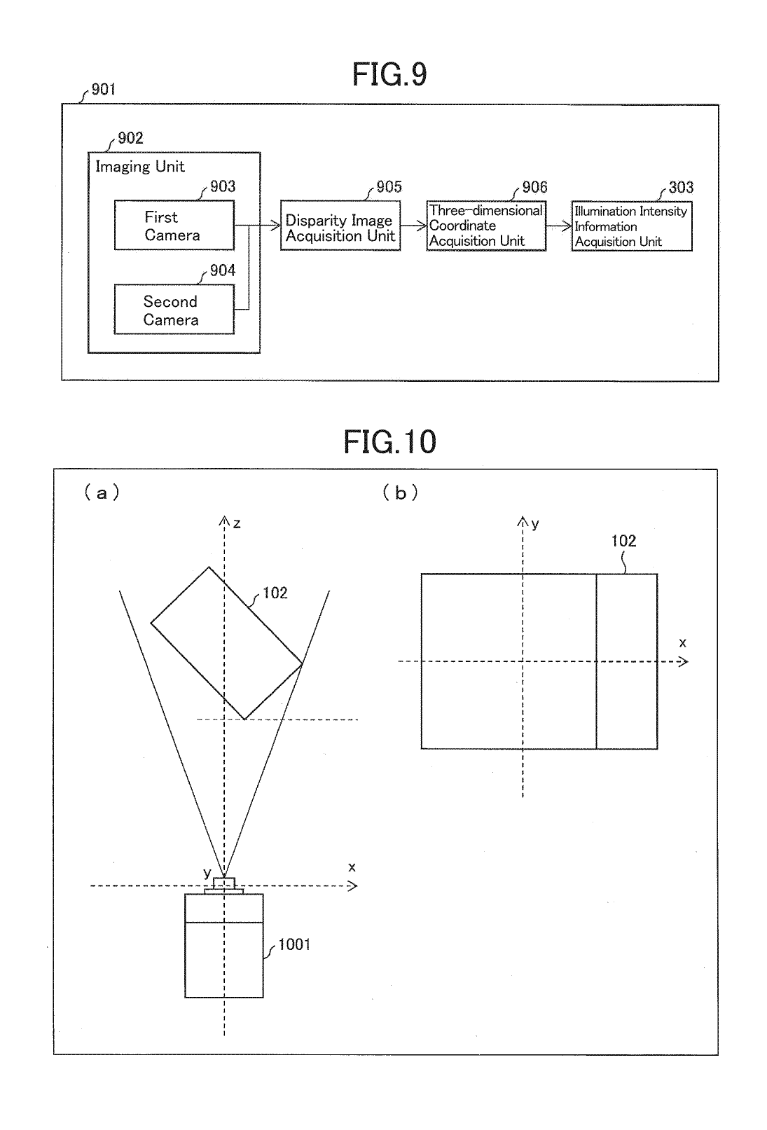

The following will describe another embodiment of the present invention (Embodiment 3) in reference to FIGS. 9 to 11. For convenience of description, members of the present embodiment that have the same function as members of any previous embodiment are indicated by the same reference numerals, and description thereof is omitted. The present embodiment describes a method of acquiring the shape of a projection medium, as well as acquiring an illumination intensity distribution by an illumination intensity distribution acquisition unit.

The methods described in Embodiments 1 and 2 detect the location of a projection surface 103 of the projection medium 102 to project video onto the projection surface 103. If the projection medium 102 has an irregular surface, and the video can be projected only onto a single projection surface 103, the projection device 101 can only project video that can be superimposed on the single projection surface 103, which limits the video content that can be projected. Accordingly, in the present example, the illumination intensity distribution acquisition unit 201 acquires both an illumination intensity distribution and the three-dimensional shape of the projection medium 102 so that the three-dimensional coordinates of the projection surface 103 can be acquired for video projection even if the projection medium 102 has an irregular surface.

### Configuration of Functional Blocks

The projection device 101 has its functional blocks configured similarly to Embodiment 1 (see FIG. 2), except for the following respects. The present embodiment differs from Embodiments 1 and 2 in that in the former, an illumination intensity distribution acquisition unit 901 is configured to acquire the shape of the projection medium 102 and also that, again in the former, the projection processing unit 206 deforms (converts) the video contained in the content information acquired by the content information acquisition unit 203 in accordance with the three-dimensional shape of the projection medium 102. The “deformation” (“conversion”) here encompasses increasing and decreasing the display size of the video contained in the content information acquired by the content information acquisition unit 203.

### Configuration of Illumination Intensity Distribution Acquisition Unit

FIG. 9 is a diagram of an exemplary configuration of functional blocks in the illumination intensity distribution acquisition unit 901 in accordance with the present embodiment. Referring to FIG. 9, the illumination intensity distribution acquisition unit 901 includes an imaging unit 902, a disparity image acquisition unit 905, a three-dimensional coordinate acquisition unit 906, and an illumination intensity information acquisition unit 303.

The imaging unit 902 captures an image covering an area that includes the projection medium 102. The imaging unit 902 includes a first camera 903 and a second camera 904. In an aspect of the present invention, each of the first camera 903 and the second camera 904 is configured to include: optical components for capturing an image of an imaging space; and an imaging device such as a CMOS or a CCD. The first camera 903 and the second camera 904 generate image data representing a captured image from electric signals generated through photoelectric conversion. The first camera 903 and the second camera 904 may output raw generated image data, may first subject the generated image data to image processing such as luminance imaging and/or noise reduction in a video processing unit (not shown) before outputting the image data, and may output both the raw generated image data and the processed image data. Furthermore, in an aspect of the present invention, the first camera 903 and the second camera 904 are configured so as to transmit camera parameters used in the imaging such as an aperture value and a focal length to the storage unit 204.

The disparity image acquisition unit 905 calculates a disparity image from both an image captured by the first camera 903 and an image captured by the second camera 904 in the imaging unit 902. The disparity image acquisition unit 905 may be built around, for example, an FPGA or an ASIC in an aspect of the present invention. A method of calculating a disparity image will be described later in detail.

The three-dimensional coordinate acquisition unit 906 detects the three-dimensional coordinates of the projection medium 102 by referring to the images captured by the first camera 903 and the second camera 904 in the imaging unit 902, to the disparity image calculated by the disparity image acquisition unit 905, and to the installation conditions of the imaging unit 902 retrieved from the storage unit 204, thereby detecting the three-dimensional shape of the projection medium 102. The three-dimensional coordinate acquisition unit 906 may be built around, for example, an FPGA or an ASIC in an aspect of the present invention. A method of calculating three-dimensional coordinates will be described later in detail.

### Method of Acquiring Disparity Image

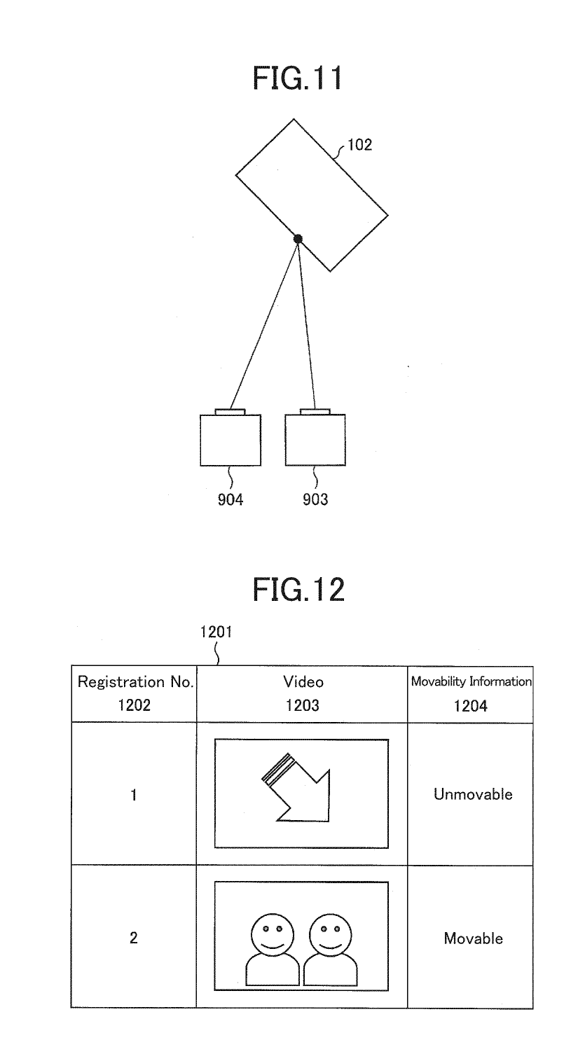

A method of acquiring a disparity image implemented by the disparity image acquisition unit 905 in accordance with the present embodiment will be described next in reference to FIGS. 10 and 11.

Portion (a) of FIG. 10 is an overhead view of a disparity image and the three-dimensional coordinates of the projection medium 102 being acquired. Portion (b) of FIG. 10 is a plan view of a disparity image and the three-dimensional coordinates of the projection medium 102 being acquired.

A coordinate system will be used for various purposes throughout the description below. The coordinate system has an origin where the illumination intensity distribution acquisition unit 901 in the projection device 1001 is located. The coordinate system has an x-axis parallel to the right/left direction in the plan view ((b) of FIG. 10) (positive to the right), a y-axis parallel to the top/bottom direction in the plan view (positive to the top), and a z-axis parallel to the top/bottom direction in the overhead view ((a) of FIG. 10) (positive to the top).

A method of acquiring a disparity image implemented by the illumination intensity distribution acquisition unit 901 in accordance with the present embodiment will be described next.

Disparity indicates a difference between the locations of a subject in two images captured from different angles. Disparity is represented visually in a disparity image.

The first camera 903 (right) and the second camera 904 (left) are positioned next to each other, both facing the projection medium 102. FIG. 11 is a diagram showing their relative locations as viewed exactly from above. FIG. 11 shows the first camera 903 and the second camera 904, the left one of which (second camera 904) provides a reference (reference camera). The coordinate system of this camera is used as a reference coordinate system. Assume that these two cameras have the same properties and are installed in completely horizontal positions. If the two cameras have different properties and/or are not installed in horizontal positions, the present embodiment is still applicable after being calibrated based on camera geometry. Detailed description is omitted. The first camera 903 and the second camera 904 may be transposed without disrupting the integrity of the present embodiment.

The disparity image acquisition unit 905 can determine a disparity by selecting a local block of a prescribed size in an image captured by a reference camera (second camera 904), extracting a local block corresponding to the selected local block from an image captured by another camera by block matching, and calculating an offset level between the two local blocks.

Letting IR(u,v) represent the luminance level of a pixel (u,v) in the image captured by the first camera 903, IL(u,v) represent the luminance level of a pixel (u,v) in the image captured by the second camera 904, and P represent a block matching-based search range for local blocks, a disparity M(u,v) is calculated by Equation 8 below if each local block has a size of 15×15.

$$\begin{matrix}[ Math . 8 ] & \\ M ( u , v ) = {argmin}_{dx ∈ P} ( {\sum }_{s = - 7}^{7} {\sum }_{t = - 7}^{7} ( \vert {I}_{L} ( u + s , v + t ) - {I}_{R} ( u + s - dx , v + t ) \vert ) ) & ( Eq . 8 )\end{matrix}$$

Since the first camera 903 and the second camera 904 are installed in horizontal positions, the block matching-based search needs only to be conducted in horizontal directions. In addition, since a search camera is installed to the right of the reference camera, the search needs only to be conducted on the left-hand side (negative direction of the x-axis) of corresponding pixels.

By this method can the disparity image acquisition unit 905 calculate a disparity image. This is, however, not the only possible method to calculate a disparity image. Any method may be used that can calculate a disparity image for cameras installed at different positions.

### Method of Acquiring Three-Dimensional Coordinates of Projection Medium

A method of acquiring the three-dimensional coordinates of the projection medium 102 implemented by the three-dimensional coordinate acquisition unit 906 will be described next.

The three-dimensional coordinate acquisition unit 906 needs camera parameters representing properties of the image capturing cameras to calculate three-dimensional coordinates from a disparity image. The camera parameters include intrinsic parameters and extrinsic parameters. The intrinsic parameters include the focal length and principal point of the camera. The extrinsic parameters include a rotation matrix and translation vector for two cameras.

The three-dimensional coordinate acquisition unit 906 can calculate the three-dimensional coordinates of the projection medium 102 by retrieving camera parameters from the storage unit 204 and using a focal length f (unit: meters) and a camera-to-camera distance b (unit: meters) as detailed below in an aspect of the present invention.

The three-dimensional coordinate acquisition unit 906 is capable of calculating the three-dimensional coordinates (Xc,Yc,Zc) of a point that corresponds to a pixel (uc,vc) in the imaging face of the reference camera in accordance with triangulation principles from Equations 9 to 11 by using the focal length f, the camera-to-camera distance b, and the disparity M(uc,vc).

$$\begin{matrix}[ Math . 9 ] & \\ {X}_{c} = \frac{{u}_{c} \times b}{M ( {u}_{c} , {v}_{c} ) \times q} & ( Eq . 9 ) \\ [ Math . 10 ] & \\ {Y}_{c} = \frac{{v}_{c}}{M ( {u}_{c} , {v}_{c} ) \times q} & ( Eq . 10 ) \\ [ Math . 11 ] & \\ {Z}_{c} = \frac{f \times b}{M ( {u}_{c} , {v}_{c} ) \times q} & ( Eq . 11 )\end{matrix}$$

In these equations, q is a length (unit: meters) per pixel and has a value that is unique to the imaging device of the camera. The offset level of a pixel can be converted to a real distance disparity by using the product of M(uc,vc) and q.

The three-dimensional coordinate acquisition unit 906 may measure the three-dimensional coordinates of any point on the reference camera by this method and acquire the three-dimensional shape of the projection medium 102 by specifying pixels that represent the area occupied by the projection medium 102. These pixels may be specified by any method: for example, the pixels may be picked up by the user.

The imaging unit 301 does not necessarily include two cameras and may be any imaging unit capable of directly calculating a disparity or a three-dimensional shape. For example, the imaging unit 301 may be based on a TOF (time of flight) technique in which a distance is measured on the basis of the reflection time of infrared light to and back from an imaged subject.

### Method of Generating Graphic Data

Next, a description will be given of a method of the projection processing unit 206 generating graphic data used to project the video contained in the content information acquired by the content information acquisition unit 203 onto the projection area determined by the projection area determining unit 205 in the present embodiment.

First, the projection processing unit 206 refers to a projection area G(i) determined by the projection area determining unit 205 to associate N feature points in the projection area G(i) with pixels in the video to be projected by the projector 202. The three-dimensional coordinates of the feature points are denoted by (Xn,Yn,Zn). The three-dimensional coordinates of the feature points in the projection area G(i) and the pixels (u′n,v′n) in the video to be projected by the projector 202 have the relation represented by Equation 12.

$$\begin{matrix}[ Math . 12 ] & \\ s ( \begin{matrix}{u}_{n}^{′} \\ {v}_{n}^{′} \\ 1\end{matrix} ) = A ( R ( \begin{matrix}{X}_{n} \\ {Y}_{n} \\ {Z}_{n}\end{matrix} ) + T ) ( n = 1 , 2 , … , N ) & ( Eq . 12 )\end{matrix}$$

In Equation 12, s is a parameter that varies with projection distance, A is a 3×3 matrix representing intrinsic parameters of the projector, R is a 3×3 matrix representing a rotation of the coordinate system of the projector and the coordinate system of the camera, and T is a vector representing a translational motion of the coordinate system of the projector and the coordinate system of the camera. A, R, and T can be acquired, for example, by a general-purpose method such as Zhang's method.

Subsequently, the projection processing unit 206 acquires the vertex coordinates (m1,n1), (m2,n2), (m3,n3), and (m4,n4) of the video contained in the content information acquired by the content information acquisition unit 203. The projection processing unit 206 converts the video using the vertex coordinates of the projection area G(i) and the vertex coordinates of the video in order to generate graphic data. The video may be converted using, for example, the conversion formula of Equation 3.

The arrangement described above provides a method by which even if the projection medium 102 has an irregular surface, the three-dimensional coordinates of the projection surface 103 can be acquired for video projection by the illumination intensity distribution acquisition unit 201 acquiring the three-dimensional shape of the projection medium 102 as well as an illumination intensity distribution.

### Embodiment 4

The following will describe another embodiment of the present invention (Embodiment 4) in reference to FIG. 12. For convenience of description, members of the present embodiment that have the same function as members of any previous embodiment are indicated by the same reference numerals, and description thereof is omitted.

In the present embodiment, the content information additionally includes movability information that represents whether or not the projection (projection destination) of each video is movable. A video for which the movability information is “movable” is projected onto the projection area 104 determined in accordance with the illumination intensity distribution detected by the illumination intensity distribution acquisition unit 201. A video for which the movability information is “unmovable” is projected onto a predetermined fixed area regardless of the illumination intensity distribution acquired by the illumination intensity distribution acquisition unit 201. This method makes it possible to project, onto a predetermined particular area, a video for which the location of the projection is more important than the visibility of the video.

### Configuration of Functional Blocks

The projection device 101 has its functional blocks configured similarly to Embodiment 1 (see FIG. 2), except for the following respects. The present embodiment differs from Embodiments 1 to 3 in that in the former, a content information acquisition unit 303 acquires content information that includes movability information for the video and also that, again in the former, the control unit 207 controls the location of the projected video (projection destination) in accordance with the movability information.

### Content Information

Content information in accordance with the present embodiment will be described in reference to FIG. 12. FIG. 12 is a diagram showing a data structure of content information 1201.

Referring to FIG. 12, the content information 1201 includes a registration number 1202, a video 1203, and movability information 1204.

The registration number 1202 is a number that is unique to the content information 1201 to be registered. The video 1203 is content to be projected. The movability information 1204 is information based on which it is controlled whether or not to allow the video 1203 of the registration number 1202 to be moved in accordance with an illumination intensity distribution. The video contained in content information is associated with movability information in this manner.

If the movability information 1204 associated with a video contained in content information is “unmovable,” the control unit 207 controls the projection processing unit 206 and the projector 202 so as to project the video onto a predetermined projection destination. On the other hand, if the movability information 1204 is “movable,” the control unit 207 controls the projection processing unit 206 and the projector 202 so as to project the video onto the projection area 104 determined by the projection area determining unit 205.

The arrangement described above provides a method by which the content information additionally includes movability information, and it is controlled whether or not to set up a projection area in accordance with an illumination intensity distribution and the movability information.

### Types of Content Projected by Projection Device

The description so far has assumed that the projection device 101 projects a video (content). The projection device 101 may, however, project any content including, in addition to video (moving images), graphics, text, symbols, still images, and combinations thereof.

### Software Implementation

The control blocks of the projection device 101 (particularly, the projection area determining unit 205, the projection processing unit 206, and the control unit 207) may be implemented by logic circuits (hardware) fabricated, for example, in the form of an integrated circuit (IC chip) and may be implemented by software executed by a CPU (central processing unit).

In the latter form of implementation, the projection device 101 includes among others a CPU that executes instructions from programs or software by which various functions are implemented, a ROM (read-only memory) or like storage device (referred to as a “storage medium”) containing the programs and various data in a computer-readable (or CPU-readable) format, and a RAM (random access memory) into which the programs are loaded. The computer (or CPU) then retrieves and executes the programs contained in the storage medium, thereby achieving the object of an aspect of the present invention. The storage medium may be a “non-transient, tangible medium” such as a tape, a disc, a card, a semiconductor memory, or programmable logic circuitry. The programs may be fed to the computer via any transmission medium (e.g., over a communications network or by broadcasting waves) that can transmit the programs. The present invention, in an aspect thereof, encompasses data signals on a carrier wave that are generated during electronic transmission of the programs.

### Summation

The present invention, in an aspect thereof (aspect 1), is directed to a projection device (101) including: a projection unit (projector 202) configured to project content onto a projection medium (102); an illumination intensity distribution detection unit (201) configured to detect an illumination intensity distribution on a projection surface (103) of the projection medium; and a projection area determining unit (205) configured to determine a projection area for the content by referring to the illumination intensity distribution detected by the illumination intensity distribution detection unit.

This arrangement can set up a projection area for a projection device that projects content onto a projection medium, in such a manner as to restrain the visibility of the content from being reduced by the brightness of the projection medium, by detecting an illumination intensity distribution on a projection surface of the projection medium and determining the projection area in accordance with the detected illumination intensity distribution.

In an aspect of the present invention (aspect 2), the projection device of aspect 1 may be configured such that the projection area determining unit detects, out of a plurality of subareas into which the projection surface is divided, subarea groups each composed of those contiguous subareas that have an illumination intensity lower than or equal to a threshold by referring to the illumination intensity distribution and determines one of the detected subarea groups as the projection area.

This arrangement can determine a projection area in a more suitable manner.

In an aspect of the present invention (aspect 3), the projection device of aspect 1 or 2 may be configured such that while the projection unit is projecting the content, the projection area determining unit determines a projection area for the content by additionally referring to a post-start illumination intensity distribution detected in advance by the illumination intensity distribution detection unit after starting the projection.

This arrangement can re-acquire an illumination intensity distribution during the projection of the content and properly update projection area settings in accordance with this illumination intensity distribution re-acquired during the projection.

In an aspect of the present invention (aspect 4), the projection device of any one of aspects 1 to 3 may further include a graphic data generating unit (projection processing unit 206) configured to generate graphic data to project the content by deforming the content in accordance with the projection area determined by the projection area determining unit, wherein the projection unit projects the content onto the projection area by using the graphic data.

This arrangement can project the content onto the projection area determined by the projection area determining unit in a satisfactory manner.

In an aspect of the present invention (aspect 5), the projection device of aspect 4 may further include a three-dimensional shape detection unit (three-dimensional coordinate acquisition unit 906) configured to detect a three-dimensional shape of the projection medium, wherein the graphic data generating unit deforms the content in accordance with the three-dimensional shape of the projection medium detected by the three-dimensional shape detection unit.

This arrangement can detect the three-dimensional shape of the projection medium, thereby enabling the projection of the content in accordance with the three-dimensional shape of the projection medium.

In an aspect of the present invention (aspect 6), the projection device of any one of aspects 1 to 5 may be configured such that the content is associated with movability information representing whether the content has a movable projection destination or has an unmovable projection destination, the projection device further including a control unit (207) configured to refer to the movability information and to cause the projection unit to project the content onto the projection area determined by the projection area determining unit if the movability information indicates that the content has a movable projection destination and onto a predetermined area if the movability information indicates that the content has an unmovable projection destination.

This arrangement can control whether or not to determine a projection area in accordance with an illumination intensity distribution by referring to the movability information associated with the content.

The present invention, in an aspect thereof (aspect 7), is directed to a method of a projection device projecting content onto a projection medium, the method including: the illumination intensity distribution detection step of detecting an illumination intensity distribution on a projection surface of the projection medium; and the projection area determining step of determining a projection area for the content by referring to the illumination intensity distribution detected in the illumination intensity distribution detection step.

This arrangement can achieve the same advantages as the projection device of aspect 1.

The projection device of any aspect of the present invention may be implemented on a computer, in which case the present invention encompasses a projection control program that, for the projection device, causes a computer to realize the projection device by causing the computer to operate as the various units (software elements) of the projection device and also encompasses a computer-readable storage medium containing the projection control program.

The present invention is not limited to the description of the embodiments above and may be altered within the scope of the claims. Embodiments based on a proper combination of technical means disclosed in different embodiments are encompassed in the technical scope of the present invention. Furthermore, a new technological feature may be created by combining different technological means disclosed in the embodiments.

The description of each embodiment above assumes that various functions are provided by distinct elements. In real practice, however, it is not essential to implement the functions with such clearly distinguishable elements. A remote operation assisting device for realizing the functions in the embodiments may do so, for example, by actually including different elements for different functions or including an LSI chip that single-handedly implements all the functions. In other words, no matter how the functions are implemented, the elements are functional, not physical. A selection may also be made from the elements of the present invention for new embodiments without departing from the scope of the present invention.

### CROSS-REFERENCE TO RELATED APPLICATIONS

The present application claims the benefit of priority to Japanese Patent Application, Tokugan, No. 2016-138024, filed on Jul. 12, 2016, the entire contents of which are incorporated herein by reference.

### REFERENCE SIGNS LIST

101 Projection Device
102 Projection Medium
103 Projection Surface (Projectable Region)
104 Projection Area
201 Illumination Intensity Distribution Acquisition Unit (Illumination Intensity Distribution Detection Unit)
202 Projector (Projection Unit)
205 Projection Area Determining Unit
206 Projection Processing Unit (Graphic Data Generating Unit)
207 Control Unit
906 Three-dimensional Coordinate Acquisition Unit (Three-dimensional Shape Detection Unit)

1. A projection device comprising:
an illumination intensity distribution detection circuitry configured to detect an illumination intensity distribution in a projectable region; and
a projection area determining circuitry configured to determine a projection area to project content onto a projection medium based on the illumination intensity distribution,
wherein while a projection circuitry is projecting the content onto the projection area, the projection area determining circuitry determines the projection area based on a post-start illumination intensity distribution detected by the illumination intensity distribution detection circuitry after starting the content projection.

2. (canceled)

3. (canceled)

4. (canceled)

5. The projection device according to claim 1, wherein the content is either first content having a movable projection destination or second content having an unmovable projection destination, the projection device further comprising a control circuitry configured to cause the projection circuitry to project the content onto the projection area determined by the projection area determining circuitry if the content is first content and onto a predetermined area if the content is second content.

6. (canceled)

7. (canceled)

8. (canceled)

9. (canceled)

10. The projection device according to claim 1, wherein while the projection circuitry is projecting the content onto the projection area, the projection area determining circuitry determines the projection area based also on a pre-start illumination intensity distribution detected by the illumination intensity distribution detection circuitry before starting the content projection.

11. A projection method comprising:
an illumination intensity distribution detection circuitry detecting an illumination intensity distribution in a projectable region; and
a projection area determining circuitry determining a projection area to project content onto a projection medium based on the illumination intensity distribution,
wherein while a projection circuitry is projecting the content onto the projection area, the projection area determining circuitry determines the projection area based on a post-start illumination intensity distribution detected by the illumination intensity distribution detection circuitry after starting the content projection.

12. A storage medium containing a program causing a computer to function as:
an illumination intensity distribution detection circuitry that detects an illumination intensity distribution in a projectable region; and
a projection area determining circuitry that determines a projection area to project content onto a projection medium based on the illumination intensity distribution,
wherein while a projection circuitry is projecting the content onto the projection area, the projection area determining circuitry determines the projection area based on a post-start illumination intensity distribution detected by the illumination intensity distribution detection circuitry after starting the content projection.
